(19) United States
(12) Patent Application Publication
(10) Pub. No.: US 2003/0137626 A1
(43) Pub. Date: Jul. 24, 2003

(54) Method of making a passive patterned retarder and retarder made by such a method

(76) Inventors: Marina Khazova, Oxfordshire (GB); Grant Bourhill, Stow-on-the Wold (GB); Heather Stevenson, Oxford (GB)

Correspondence Address: Neil A. DuChez, Renner, Otto, Boisselle & Sklar, LLP, Nineteenth Floor, 1621 Euclid Avenue, Cleveland, OH, 44115, US

(21) Appl. No.: 10/322,971

(22) Filed: Dec. 18, 2002

(30) Foreign Application Priority Data
Jan. 18, 2002 (GB) 0201156.7

(51) Int. Cl. G02F 1/1335

(52) U.S. Cl. 349/117

(57) ABSTRACT

A method is provided of making a passive patterned retarder, in which a liquid crystal alignment surface is formed. The alignment surface 37 comprises sets of regions. Each region comprises a grating-like structure having elongate surface relief features aligned in the same alignment direction. The alignment directions of different sets are different from each other. The alignment surface is coated in a layer of fixable liquid crystal material 38 whose optic axis is oriented by the underlying grating-like structure. The liquid crystal material is then fixed so that the optic axis is defined and fixed by the underlying grating-like structures.

### BACKGROUND OF THE INVENTION

1. Field of the Invention

The present invention relates to a method of making a passive patterned retarder and to a passive patterned retarder made by such a method. Such retarders have many applications including, for example, polarisation conversion optical systems for liquid crystal device (LCD) projectors and three dimensional autostereoscopic displays.

2. Description of the Related Art

FIG. 1 of the accompanying drawings illustrates a known type of polarisation conversion system for supplying light of a single linear polarisation, for example to illuminate an LCD in a projector. Such an arrangement includes a light source in the form of a lamp 1 and a reflector 2 with a first microlens array 3 which directs light on to a second microlens array 4. The microlens array 4 directs unpolarised light to a polarisation splitter 5 provided on its light output surface with a patterned retarder 6, only some of whose retardation elements are shown. The pitch of the polarisation splitter 5 is half the pitch of the second microlens array 4. A crosstalk block 7 ensures that stray light does not interfere with the operation of the polarisation splitter 5 and the patterned retarder 6.

As shown in the enlarged detail at 8, the polarisation splitter 5 comprises an array of polarisation separating elements illustrated as polarisation separating prisms. The incident light from the lamp 1 is substantially non-polarised and comprises S and P polarisations and the light of the S polarisation passes directly through the prisms. Light of the S polarisation is reflected through 90° at a surface 9 and is again reflected through 90° at a surface 10 so as to be directed out of the polarisation splitter 5 in the same direction as the light of the P polarisation. However, the light of the P polarisation passes through a retarder element 11 of the patterned retarder 6, which element is in the form of a half wave plate. This converts the light of the P polarisation to light of the S polarisation so that substantially all of the light leaving the arrangement shown in FIG. 1 is of the same S polarisation. Such an arrangement is of substantially greater light efficiency compared with arrangements in which light of one polarisation is merely prevented from being used.

Polarisation conversion systems for LCD projection displays making use of patterned retarders are disclosed in, for example, U.S. Pat. Nos. 6,084,714, 6,278,552, 6,154,320, 5,986,809 and 5,555,186. However, these patents do not disclose any techniques for making patterned retarders or for providing broadband patterned retarders with improved achromatic performance.

Commercially available LCD projection displays have retarder arrangements made as arrays of half wave plate retarder stripes cut from a stretched birefringent polymer. Each of the stripes has to be accurately aligned with respect to and attached to the light emitting surface of a polarisation splitting element, for example as illustrated in FIG. 1. In order to improve the broadband spectral efficiency by correcting for chromatic dispersion, a birefringent polymer is used in the form of a stack of several layers of retarder material. Precision cutting of the retarder stripes and the alignment of the individual stripes with respect to the polarisation splitter limits the smallest retarder feature size to approximately 1.8 mm. In the case of striped retarders, this means that the individual stripes have a minimum width of the order of 1.8 mm. This limits the smallest overall physical dimensions of the polarisation conversion unit that can be obtained and, therefore, limits the size of a projector. Furthermore, it restricts the homogenisation of the output of the lamp 1 and the uniformity of the illumination of the LCD panel.

In order to avoid having to align each individual retarder element, it is known to make the patterned retarder as a single substrate element. For example, U.S. Pat. No. 5,327,285 discloses a process for making a patterned retarder by chemical etching or mechanical removal of birefringent material, such as polyvinyl alcohol (PVA). Such a technique has the disadvantage that different regions of the patterned retarder have different light absorption properties. To avoid or reduce this effect, a subsequent polarisation step may be performed but this requires a further processing step. Also, the edge definition of the region is relatively poor and this again limits the smallest feature size of the pattern which can be provided. Also, this technique cannot produce regions with different retarder optic axis orientations on a single substrate so that, where such devices are required, two or more substrates must be processed and then attached to each other with the precise registration. Again, this restricts the smallest feature size of the pattern.

EP 0 887 667 discloses a technique for making a patterned retarder with much smaller feature sizes. One example of this technique is illustrated in simplified form in FIG. 2 of the accompanying drawings. The patterned retarder is formed on a transparent substrate 15. An alignment layer suitable for aligning a polymerisable liquid crystal material is formed on the substrate and is rubbed in a first direction indicated as “A” so that the alignment layer 16 is capable of aligning the optic axis of the liquid crystal material in the direction A.

A photoresist layer 17 is then formed on the rubbed alignment layer 16 and is exposed by, for example, ultraviolet radiation through a mask 18. The exposed photoresist layer 17 is developed to reveal openings such as 19, through which the alignment layer 16 is then rubbed in a second direction indicated by “B”. The remainder of the photoresist layer 17 is removed to reveal the alignment layer 16 with regions rubbed so as to align the optic axis of the liquid crystal material in the direction A alternating with regions rubbed to align the optic axis of the liquid crystal material in the direction B.

A layer 20 of a polymerisable liquid crystal material is then formed on the alignment layer 16 so that the local optic axis of the liquid crystal material is aligned in the alignment direction of the underlying region of the alignment layer 16. The layer 20 is then polymerised so as to fix the optic axis of the material. Thus, regions such as 21 of the layer 20 have their optic axes aligned in the direction A whereas other regions such as 22 have their optic axis aligned in the direction B.

FIG. 3 of the accompanying drawings illustrates an example of the use of a patterned retarder made by the method illustrated in FIG. 2 as a latent switchable parallax barrier for a 3-D autostereoscopic display. The retarder 25 acts as a latent parallax barrier which is visible when viewed through an output polariser 26. FIG. 3 shows an LCD output polariser 27 whose polarisation direction is oriented at 45° to a reference direction which, in the arrangement illustrated, is the vertical direction.

The retarder 25 provides a halfwave of retardation and comprises regions 21 with an optic axis oriented at 45° and regions 22 with an optic axis oriented at 0°. The regions 21 do not affect the polarisation of light from the LCD polariser 27 whereas the regions 22 rotate the polarisation by 90°. This patterned retarder does not have any effect on the LCD panel when the 3-D output polariser 26 is not in use.

The 3D output polariser 26 has a polarisation direction oriented at 135° and when used to analyse the output from the 3-D display blocks light from the regions 21 and passes light from the regions 22 so as to reveal the latent parallax barrier structure.

U.S. Pat. No. 6,222,672 discloses an imaging system with improved achromatic performance by providing compensation of chromatic dispersion in a patterned retarder made by a multi-rubbing technique and comprising a reactive mesogen. Such a patterned retarder comprises first retarder regions in the form of halfwave plates with optic axes oriented at equal but opposite angles to a reference direction stacked with a further halfwave plate whose optic axis is oriented at 67.5° to the reference direction.

There are various known arrangements in which spatially patterned alignment layers are used for providing multi-domain alignment of liquid crystal materials. For example, EP 0 689 084 discloses a linearly photopolymerisable material which may be used as a patterned alignment layer for birefringent materials. In order to produce a retarder having regions of different optic axis orientations, two or more photolithagraphic steps are required in order to expose the linearly photopolymerisable alignment material. These steps must be correctly registered with each other and this adds to the complexity of the process and reduces the pitch tolerance of the resulting patterned retarder.

“Four domain TN-LCD fabricated by reverse rubbing or double evaporation”, SID95 Digest, p 865 and “Two domain 80° twisted nematic for grey scale applications”, Japanese Journal of Applied Physics, vol. 31, p 2, 11B, pL1603 disclose multi-domain LCDs for providing improved viewing angle performance.

“Mechanism of liquid crystal alignment on submicron patterned surfaces”, A. Rategar et al, Journal of Applied Physics, vol. 89, no. 2, pp 960-964, 2001 discloses the alignment of liquid crystals on polymeric surfaces which have been patterned using an atomic force microscope. This document analyses multi-domain alignment of liquid crystals on micro-structured surfaces having different orientations of micro grooves.

U.S. Pat. No. 5,917,570 discloses a display device in which liquid crystals are aligned on “bi-gratings” with one symmetrical grating and one asymmetrical grating orthogonal thereto. The bi-grating profile is formed by two exposures of a photoresist through orthogonal masks. Alternatively, the gratings may be formed by embossing. These techniques are disclosed for multi-domain liquid crystal pixels.

“Control of liquid crystal alignment using stamped-morphology method”, E. S. Lee et al, Japanese Journal of Applied Physics, vol. 32, pp L1436-L1438, 1993 discloses a technique for single-domain alignment of liquid crystals using micro groves which are formed by a stamping process.

U.S. Pat. No. 5,946,064 discloses the single domain alignment of liquid crystals on an optical alignment polymer layer coated on a heat-curable resin layer having micro groves formed therein.

### SUMMARY OF THE INVENTION

According to a first aspect of the invention, there is provided a method of making a passive patterned retarder, comprising the steps of:

forming a liquid crystal alignment surface comprising a plurality of sets of regions, the regions of each set comprising grating-like structures having elongate surface relief features substantially aligned in the same alignment direction with the alignment directions of the sets being different from each other;

disposing on the alignment surface a layer of fixable liquid crystal material whose optic axis is oriented by the grating-like structures; and

fixing the liquid crystal material so that the optic axis of each region of the fixed liquid crystal material overlying a respective one of the regions of the alignment surface is fixed in a direction defined by the alignment direction of the respective region.

The term “passive” is used herein to refer to a patterned retarder whose optical properties, particularly retardation and direction of optic axis, are fixed during manufacture and cannot be controlled or varied following manufacture and during use. This contrasts with active devices, such as LCDs in which the optical properties are controlled so as to vary in a desired way during use of such devices following manufacture.

The term “grating-like structure” as used herein is defined to mean a structure having surface relief features comprising elongate ridges and/or valleys extending substantially parallel to each other across the surface. Such ridges and/or valleys, which may also be referred to as elongate surface relief features, may (but need not) extend continuously across the whole structure. Such features may have cross sectional shapes (in a plane perpendicular to the surface and to the elongate direction of the features) which can be substantially symmetrical or asymmetrical. It should be noted however that the spacing between adjacent surface relief features may vary within a set and/or between sets over the structure in such a way that the structure does not give rise to significant diffraction effects, and the term “grating-like structure” is therefore used in preference to “grating structure”. The term “grating-like” structure is intended to mean any structure having surface relief features that individually are of the general type suitable for use in a diffraction grating, but without requiring that the spacing between adjacent surface relief features has the uniformity or periodicity required to produce diffraction effects. Indeed, it may be preferable to choose the spacing between adjacent surface relief features so as substantially to prevent diffraction effects from occurring.

The surface relief features may have depths between 0.02 and 5 micron.

The surface relief features may have widths between 0.2 and 10 microns.

The surface relief features of each region may be substantially parallel to one another and to the alignment direction of the respective region.

The spacing, perpendicular to the alignment direction, between adjacent surface relief features may vary within a region.

The spacing, perpendicular to the alignment direction, between adjacent surface relief features may vary between a region in one set and another region within the one set.

The spacing, perpendicular to the alignment direction, between adjacent surface relief features may vary between a region within one set and a region within another set.

The liquid crystal material may be polymerisable (such as photo polymerisable (such as by ultraviolet irradiation)) and the fixing step may comprise polymerising the material. The liquid crystal material may comprise a reactive mesogen.

The alignment surface may comprise two sets of regions.

The regions may comprise substantially parallel stripes with the stripes of the sets being interleaved with each other.

The method may comprise the additional step of forming a uniform retarder as part of the patterned retarder. The additional step may comprise attaching a stretched polymer layer.

The forming step or at least one of the forming steps of the surface relief feature may comprise irradiating a layer of photoresist through an amplitude mask and developing the layer.

According to a second aspect of the invention, there is provided a passive patterned retarder made by a method according to the first aspect of the invention.

It is thus possible to provide a method of making a passive pattern retarder which is simpler and more convenient than known methods. For example, the number of individual steps may be reduced and the need for accurate registration can be reduced or substantially eliminated. Smaller pattern features can be accurately produced to allow more compact optical arrangements or better uniformity of illumination to be achieved.

### BRIEF DESCRIPTION OF THE DRAWINGS

The present invention will be further described, by way of example, with reference to the accompanying drawings, in which:

FIG. 1 illustrates the use of a patterned retarder in a known type of polarisation conversion optical system for an LCD projector;

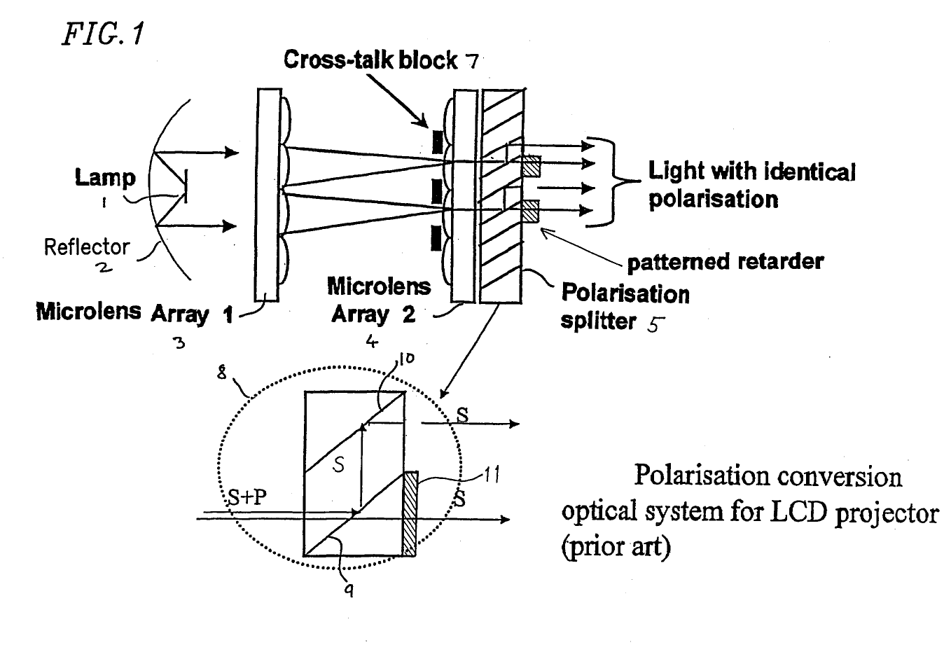

FIG. 2 illustrates the steps of a known method of making a patterned retarder;

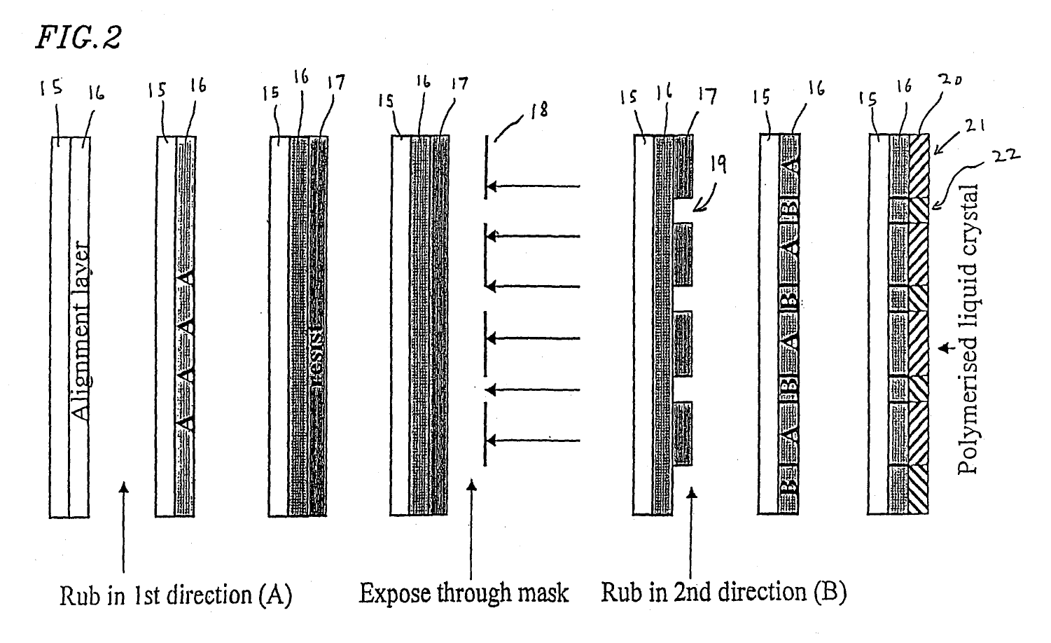

FIG. 3 illustrates a known arrangement using a patterned retarder as a parallax barrier in a three dimensional autostereoscopic display;

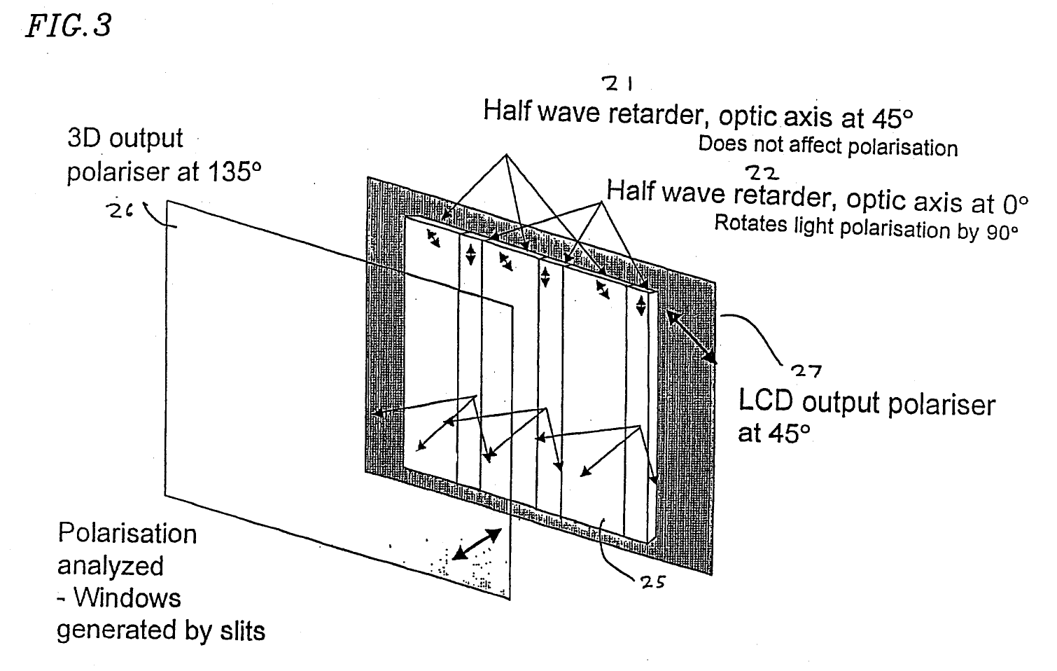

FIG. 4 is a diagram illustrating an amplitude mask for use in a method of making a passive patterned retarder constituting an embodiment of the invention; and

FIG. 5 is a diagram illustrating a method of making a patterned retarder constituting an embodiment of the invention.

### DESCRIPTION OF THE PREFERRED EMBODIMENTS

### EXAMPLE 1

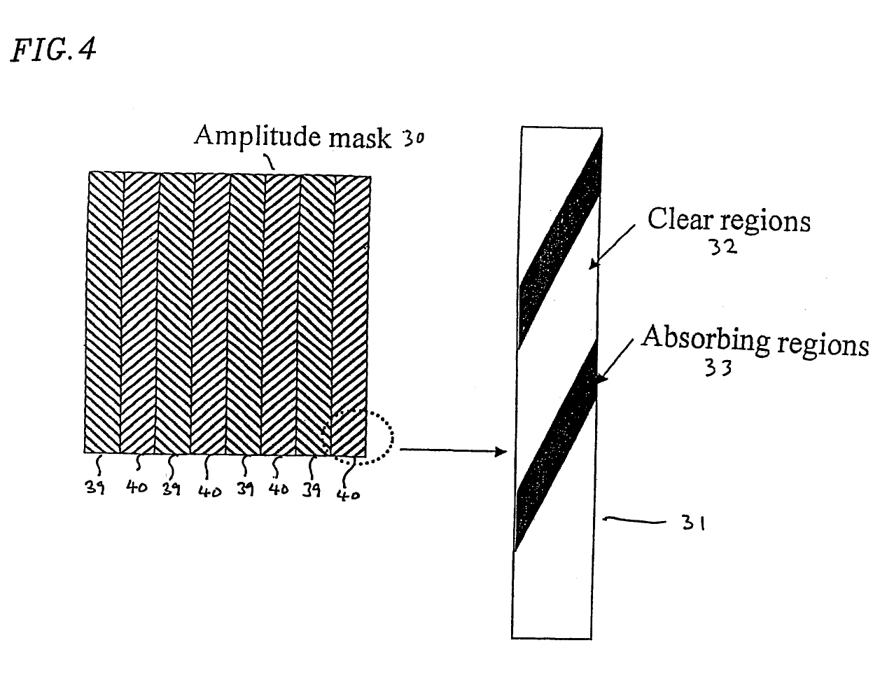

FIG. 4 illustrates an amplitude mask for use in forming an alignment layer from a layer of photo resist. The mask is, for example, formed of chrome by laser writing or by electronic beam writing and comprises two sets of regions in the form of stripes. The stripes are shown oriented vertically and the stripes of each set of regions are interleaved with the stripes of the other set of regions, so that the regions denoted by 39 comprise one set and the regions denoted by 40 comprise another set. The stripes of each set may have substantially the same width, or the stripes of one set may have a different width to the stripes of the other set. The width of the stripes correspond to the desired pitch of the eventual patterned retarder, which may be determined by the pitch of a polarisation splitting element (where the retarder is for use in a polarisation conversion optical system) or by LCD pixel pitch (where the retarder is for use in a 3-D autostereoscopic display).

A typical region of the amplitude mask 30 is shown in more detail at 31. This region 31 comprises clear, or transparent, regions such as 32 interleaved with dark, absorbing, or reflecting regions 33. The clear regions 32 pass radiation, such as ultraviolet radiation, for exposing a photoresist layer whereas the absorbing or reflecting regions 33 block such radiation.

The clear and absorbing regions 32 and 33 are in the form of fine diagonal lines which are parallel to each other in each stripe. The angle of these features corresponds to the desired angle of the optic axes of the passive patterned retarder. For example, the stripes of one set may have these features oriented at an angle of +22.5° to the vertical whereas the angle of these features of the other set is oriented at −22.5°. Alternatively, the orientation angle of these features of one set may not be equal in magnitude to the orientation angle of these features of the other set. For example, the orientation angle of these features of one set could be +22.5° and the orientation angle of these features of the other set could be −25.0°. As a further example, the orientation angle of these features of one set could be 0° and the orientation angle of these features of the other set could be −45°.

The widths of the clear and absorbing regions 32 and 33 may be the same or may be different from each other and are preferably between 0.2 and 10.0 microns. As noted above, the widths of the clear and absorbing regions 32, 33 preferably vary so as to suppress diffraction effects, although the widths of the clear and absorbing regions 32, 33 could in principle be uniform throughout the structure. For example, the widths of the clear and/or absorbing regions 32, 33 may vary within a region 39, 40, for example in a random or pseudo-random manner. Additionally or alternatively the widths of the clear and/or absorbing regions 32, 33 may vary between one region 39, 40 of a set and another region 39, 40 of the same set. Additionally or alternatively the widths of the clear and/or absorbing regions 32, 33 may vary between regions 39 of one set and regions 40 of another set.

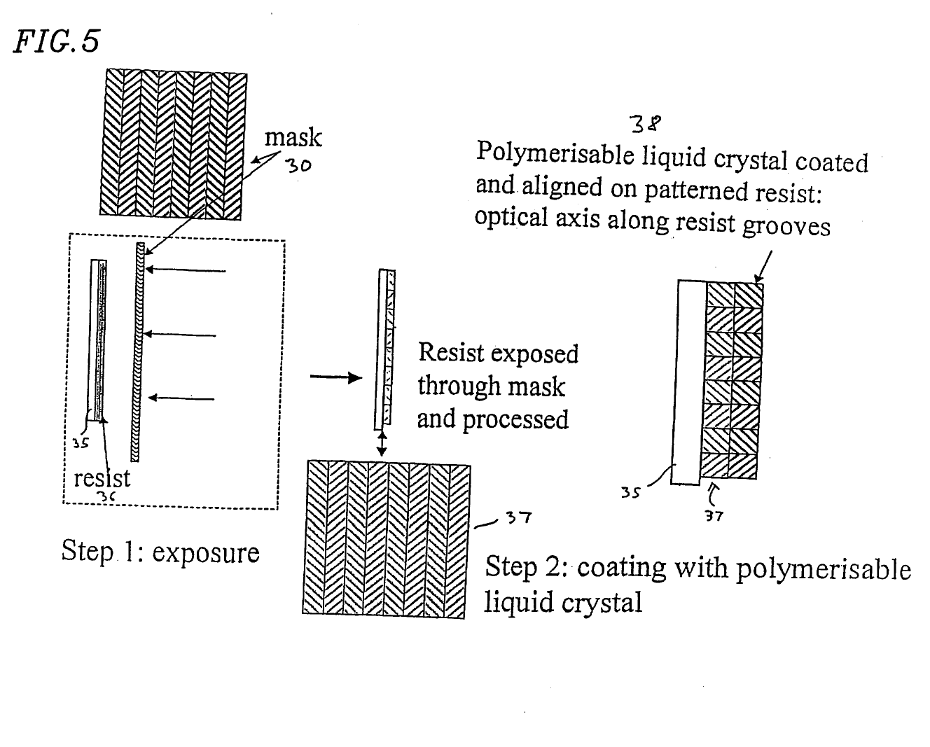

FIG. 5 illustrates a method of making a passive patterned retarder using the amplitude mask 30 illustrated in FIG. 4 to form an alignment layer. The retarder is formed on, for example, a glass or plastic substrate 35, which is appropriately cleaned and coated with a layer 36 of photo resist, for example by spin-coating or by screen-printing. In a particular example, a negative photoresist of the type SU8 2002 available from MicroChem is spun onto the substrate 35 to give a layer thickness of 0.5 microns. The resist is then soft-baked at 65° C. for one minute and at 95° C. for one minute.

The layer 36 of photoresist is then exposed to ultraviolet radiation through the mask 30 which is adjacent or in contact with the photoresist layer 36. The exposed layer 36 is then post-exposure baked for one minute at 65° C. and then for one minute at 95° C. The exposed layer 36 is developed in EC solvent available from Shipley for one minute followed by rinsing in isopropyl alcohol and drying.

These steps result in the formation of an alignment surface having a surface relief pattern corresponding nominally to the amplitude mask pattern of the mask 30. In particular, where the photoresist layer 36 was not exposed through the absorbing regions 33, the exposure and development steps result in the photoresist material being removed to leave a surface relief or grating-like pattern corresponding to the pattern of the clear regions 32 which allowed exposure of the underlying photoresist layer. In the embodiment illustrated, two sets of alignment surface regions are formed as interleaved vertical stripes. The regions of each set comprise grating-like structures with elongate surface relief features aligned in the same direction but with the features of the different sets being aligned in different directions. These directions define the optic axis of the finished retarder.

After drying, the remaining photoresist and the substrate are hard-baked for 30 minutes at between 150 and 200° C. The alignment surface formed by the residual photoresist and the adjacent surface of the substrate are then coated, for example by spin-coating or other commonly known coating technique, with a reactive mesogen, such as RMM 34 available from Merck Limited, in a 25-40% solution by weight in Xylene or PGMEA (propylene glycol monoether acetate). The reactive mesogen is aligned by the grating-like structure with its optic axis in the direction of the surface relief features of the structure. The birefringence and optical thickness of the layer 38 determine the retardation of the retarder. The optical thickness may be controlled by controlling the concentration of the coating of the solution, the spread speed and the speed of evaporation of the solvent. Fine tuning of the retardation may be controlled by accurate control of the temperature of the reactive mesogen during curing with a higher temperature giving a lower birefringence and hence lower retardation of the layer 38.

After evaporation of the solvent, the layer 38 forms regions corresponding to the underlying regions of the alignment layer 37 with the optic axis of each region being aligned in the direction of the groove of the underlying alignment layer. The reactive mesogen of the layer 38 is then cured, for example by exposure to an ultraviolet lamp having a wavelength of 365 nm with a fluence at the layer 38 of 1.5 Joules per square centimetre under a gaseous nitrogen “blanket”. The material of the layer 38 thus becomes cured or fixed by photo polymerisation so that the optical properties including the orientations of the optic axis of the regions and the birefringence are fixed.

By way of comparison with the technique disclosed in EP 0 887 667, the method described hereinbefore may be summarised as comprising following steps:

1. Coat substrate with resist;

2. Expose resist through mask;

3. Develop resist;

4. Coat with polymerisable liquid crystal;

5. Polymerise liquid crystal.

Conversely, the technique of EP 0 887 667 may be summarised as:

A. Coat substrate with alignment material;

B. Bake alignment material;

C. Rub in first direction;

D. Coat with resist;

E. Expose resist through mask:

F. Develop resist;

G. Rub over resist in second direction;

H. Flood expose resist;

I. Develop resist;

J. Coat with polymerisable liquid crystal;

K. Polymerise liquid crystal.

The present method steps 1 to 5 correspond to the method steps D to F, J and K, respectively so that the present method represents a substantial simplification in that many of the method steps of the known technique are not needed. Also, the processing tolerances of the steps 1 to 3 are reduced compared to those of the steps D to F of the known technique. The present method therefore requires fewer and simpler processing steps than the known arrangement but is capable of producing passive patterned retarders of the same quality, for example with a similar size of smallest pattern feature.

In order to improve the achromatic performance of the patterned retarder, a uniformed retarder made from stretched polymer may be laminated onto either side of the patterned retarder made by the method illustrated in FIG. 5. The optic axis of the uniform retarder is aligned appropriately, for example at −67.5° to the vertical, and the peak retardance is matched to that of the patterned retarder. Further, an anti-reflection coating may be provided and may, for example, be formed on the stretched polymer from which the uniform retarder is made. Alternatively or additionally, the surface of the substrate 35 not coated with the resist layer 36 may be provided with an anti-reflection coating.

As an alternative to making the uniform retarder from a stretched polymer sheet, the uniform retarder may be formed directly on either surface of the patterned retarder using the same process as illustrated in FIG. 5 but with an amplitude mask which comprises a single uniform region or grating-like structure across its whole surface. The widths of the clear and absorbing areas of the amplitude mask for the uniform retarder may be equal, or they may be different. The widths of the clear and absorbing areas of the amplitude mask may be equal to the line width of a mask for a patterned retarder, or they may be different. The width of the clear and absorbing areas of the amplitude mask may be uniform, or they may vary, for example in a random, or pseudo-random manner, across the mask. The uniform retarder may be formed after the completion of the patterned retarder. Alternatively, the alignment surfaces for the two retarders maybe formed on the substrate 35, after which each retarder is formed in turn by coating and fixing steps.

In the techniques described hereinbefore, the grating-like structures are formed by an “optical” transfer from a mask to a layer of photo resist.

### EXAMPLE 2

If photo resist used to from aligning surface is coloured, to improve transmission of patterned retarder and stability of retarder element under exposure of light during its operation, extra step of resist bleaching for example by exposure to UV light or by thermal treatment, may be employed after stage 3 (development). For example, patterned retarder is formed on glass or plastic substrate 35, which is appropriately cleaned and spin coated with a layer of positive resist AZ6612 of Clariant. The resist is then soft backed on a hot plate at 110 C. for 5 minutes.

The layer 36 of photo resist is exposed to UV radiation through the mask 30. Exposed resist is developed for 20 seconds in MIF726 Developer from Clariant, thoroughly rinsed in de-ionised water and dried. Dry substrates are hard baked at 150-200 C. for 30 minutes to increase transmission of resist material. Baked substrate is coated with polymerisable liquid crystal as described in Example 1.

### EXAMPLE 3

If photo resist used to form aligning surface for latent parallax barrier element of switchable 2D/3D display is coloured, to improve colour characteristics of a display device, pigment or dyes mixture may be added to photo resist to make a neutral colour. This pigment or dyes mixture may be added to photo resist composition before resist being coated onto substrate. Alternatively, pigment or dyes mixture may be added into composition of polymerisable liquid crystal.

### EXAMPLE 4

If photo resist used to form aligning surface for latent parallax barrier element of switchable 2D/3D display is coloured, to improve colour characteristics of a display device, exposed and developed resist may be additionally over coated with dyed polymer to make a neutral colour of a resulting structure. Alternatively, dyed polymer may be coated onto finished patterned retarder element after polymerisation of liquid crystal.

### EXAMPLE 5

If photo resist used to form aligning surface for latent parallax barrier element of switchable 2D/3D display is coloured, to improve colour characteristics of a display device, spectral characteristics of one or more colour filters of LTD panel may be modified to make a neutral resulting colour of device.

### EXAMPLE 6

If photo resist used to form aligning surface for latent parallax barrier element of switchable 2D/3D display is coloured, to improve colour characteristics of a display device with LED illumination, LED source may be changed for primary Red, Green Blue LEDs, with colour correction.

### EXAMPLE 7

If photo resist used to form aligning surface for latent parallax barrier element of swicthable 2D/3D display is coloured, to improve colour characteristics of a display device, size (area) or shape of one or more primary colour pixels may be modified to compensate colour change caused by resist colouration.

### EXAMPLE 8

If photo resist used to form aligning surface for latent parallax barrier element of switchable 2D/3D display is coloured, to improve colour characteristics of a display device, software colour correction may be employed to compensate colour change caused by resist colouration.

### EXAMPLE 9

If photo resist used to form aligning surface for latent parallax barrier element of switchable 2D/3D display is coloured, to improve colour characteristics of a display device, depth and width of surface relief features may be chosen such as to cause increased diffraction of light in a spectral range of relatively high transmission of resist material.

### EXAMPLE 10

If polymerisable Liquid Crystal material doesn't wet micro-structured aligning surface relief, additional step of resist surface modification, for example by conformal coating by surfactant or thermal cross-linking, may be employed after stage 3 (development).

### EXAMPLE 11

To reduce Fresnel reflection and residual diffraction from passive patterned retarder element, additional layer may be used to attach retarder to a display device or polarisation beam splitter of projection system. For example, optical adhesive with refractive index n_{ad} may be used: n₀<n_{ad}<nₑ.

What is claimed is:

1. A method of making a passive patterned retarder, comprising the steps of:
forming a liquid crystal alignment surface comprising a plurality of sets of regions, the regions of each set comprising grating-like structures having elongate surface relief features substantially aligned in the same alignment direction with the alignment direction of the sets being different from each other;
disposing on the alignment surface a layer of fixable liquid crystal material whose optic axis is oriented by the structures; and
fixing the liquid crystal material so that the optic axis of each region of the fixed liquid crystal material overlying a respective one of the regions of the alignment surface is fixed in a direction defined by the alignment direction of the respective region.

2. A method as claimed in claim 1, in which the surface relief features have depths between 0.02 and 5 micron.

3. A method as claimed in claim 1, in which the surface relief features have widths between 0.2 and 10 microns.

4. A method as claimed in claim 1, in which the surface relief features of each region are substantially parallel to one another and to the alignment direction of the respective region.

5. A method as claimed in claim 1, in which the spacing, perpendicular to the alignment direction, between adjacent surface relief features varies within a region.

6. A method as claimed in claim 1, in which the spacing, perpendicular to the alignment direction, between adjacent surface relief features varies between a region in one set and another region within the one set.

7. A method as claimed in claim 1, in which the spacing, perpendicular to the alignment direction, between adjacent surface relief features varies between a region within one set and a region within another set.

8. A method as claimed in claim 1, in which the liquid crystal material is polymerisable and the fixing step comprises polymerising the material.

9. A method as claimed in claim 8, in which the liquid crystal material is photopolymerisable.

10. A method as claimed in claim 9, in which the liquid crystal material is photopolymerisable by ultraviolet irradiation.

11. A method as claimed in claim 8, in which the liquid crystal material comprises a reactive mesogen.

12. A method as claimed in claim 1, in which the alignment surface comprises two sets of regions.

13. A method as claimed in claim 1, in which the regions comprise substantially parallel stripes with the stripes of the sets being interleaved with each other.

14. A method as claimed in claim 1, comprising the additional step of forming a uniform retarder as part of the patterned retarder.

15. A method as claimed in claim 14, in which the additional step comprises attaching a stretched polymer layer.

16. A method as claimed in claim 1, in which the forming step or at least one of the forming steps comprises irradiating a layer of photoresist through an amplitude mask and developing the layer.

17. A passive patterned retarder made by a method as claimed in claim 1.
